(19) United States
(12) Patent Application Publication
(10) Pub. No.: US 2022/0335757 A1
(43) Pub. Date: Oct. 20, 2022

(54) MOBILE MULTI-ZONE REFRIGERATOR

(71) Applicant: Cubbi Technologies Inc., Saskatoon (CA)

(72) Inventor: Dawson Norrish, Saskatoon (CA)

(21) Appl. No.: 17/722,579

(22) Filed: Apr. 18, 2022

(30) Foreign Application Priority Data
Apr. 20, 2021 (CA) 3115635

(51) Int. Cl. G07C 9/00; F25D 11/00

(52) U.S. Cl. CPC G07C 9/00182; F25D 11/003; F25D 2400/38

(57) ABSTRACT

A mobile multizone refrigerator comprises a plurality of secure refrigerated storage zones each having a lockable door connected to a zone opening controller. The zone opening controller is connected by a network interface to a server capable of receiving and facilitating zone opening requests from the user devices of affiliated users of the storage zones. Upon receipt of an authenticated zone opening request, the server will transmit a zone opening instruction to the controller affiliated with the storage zone in question, resulting in its opening. The refrigerator is mobile allowing it to be moved into and between locations with ease.

This invention is in the field of food storage equipment for commercial use and more particularly relates to a mobile multizone refrigerator which is capable of secure use by users affiliated with each zone therein.

### BACKGROUND

Both because of the recent pandemic as well as in the context of shifting workplace environments and consumer preferences, there are shifting requirements and desires on the part of consumers in various areas including that of food consumption and storage. For example in co-working environments, other office environments which have downsized or eliminated on-site food services, or scenarios in which large numbers of individuals wish to have the ability to bring their own meals or prepared food items to work or to some other type of a location for storage and eventual consumption, it is becoming more prevalent for employers and facilities operators to provide refrigeration for use.

One of the age-old problems with a refrigerator being provided for example in an office environment for various employees to use is the issue of sanitation and cleanliness where multiple users are storing food items in the fridge. Some users are better than others at keeping their items fresh and or removing expired food items, and it is never a desirable job to be responsible for cleaning the refrigerator used by multiple individuals for such storage purposes since it quite often is quite a dirty and unsanitary job. If it were possible to provide on-site refrigeration for use by multiple people in a way that individuals could more purposefully be held responsible or maintain responsibility for only a particular section of a refrigerator that was allocated for their use this would be believed to be desirable.

Another issue in shared refrigeration concepts is the potential for theft or a breach of the cleanliness or integrity of an individual's stored food items. Again if it were possible to maintain your own stored food items in a commercial, office or other shared environment in a refrigerator that was secure and was only accessible for your own use it is believed that this would also be significant from a commercial adoption perspective.

It is believed that if it were possible to provide a multizone refrigeration cabinet of sorts for use in such multiuser environments that permitted secure storage within a plurality of refrigerated storage zones, that were accessible only to affiliated users of each zone, that this would be a commercially successful refrigeration product. Development of a cabinet of type would also be capable of leverage into multiple online business food delivery and similar applications.

### SUMMARY OF THE INVENTION

The invention in a first embodiment comprises a mobile multizone refrigerator for secure use by a plurality of users. The refrigerator would consist of a refrigerated enclosure comprising a plurality of refrigerated storage zones, each of which was affiliated with a user. Individual users could each be assigned to individual refrigerated storage zones and have access only to their own assigned storage zone, providing enhanced security for items stored therein and focused or diminished responsibility for maintenance of refrigerated storage on behalf of third parties. The refrigerator includes movement means, likely a plurality of casters or the like, to permit for its streamlined movement into and between locations.

Each of the refrigerated storage zones would have a lockable door which included an electronically actuated lock. The electronically actuated lock could be connected to a power supply of the refrigerator as well as to a local control bus, by which in the correct circumstances the lock could be released allowing for the opening of the corresponding refrigerated storage zone and its door.

The refrigerator could have multiple sizes in overall dimension and could include a plurality of storage zones therein which were each identical in shape and size or volume, or various sizes of storage zones could be provided within the refrigerator. Both such approaches are contemplated within the scope of the present invention.

The refrigerator would also include a zone opening controller which would be an electronic controller comprising at least a processor and a memory as well as a network interface for network communication of the zone opening controller with a server. The server as will be detailed below will communicate with user devices for the purpose of receiving and processing zone opening requests, to actuate locks and open refrigerated storage zones in the refrigerator is acquired by affiliated and authenticated users.

The zone opening controller will also include a local control bus which is connected to each lock of a refrigerated storage zone within the refrigerator. The local control bus could be a serial interface, an internal network interface or the like, and depending upon the nature of the hardware used for the locks on the refrigerated storage zones and their lockable doors any type of a network interface capable of local control of the locks on the lockable doors of the refrigerated storage zones of the refrigerator will be understood to those skilled in the art and to be within the scope of the present invention. Finally, the zone opening controller will also include controller software for assistance and facilitation of the operation of the refrigerator.

In operation of the refrigerator, the controller can unlock the lock and door of a particular refrigerated storage zone upon receipt of a zone opening instruction from the server which corresponds to a zone opening request received at the server on behalf of the affiliated user of that storage zone. Effectively, the affiliated user of a refrigerated storage zone could, using a user device, communicate with the server to provide an authenticated zone opening request in respect of their affiliated refrigerated storage zone, and upon authentication of such a request the server would dispatch via the network connection between the server and the corresponding zone opening controller the necessary zone opening instruction to trigger the unlocking of that particular affiliated refrigerated storage zone.

The refrigerator would be mobile, so that it can be moved into position of the use location. This will permit for the rapid installation of the refrigerator as well as rendering it movable between locations when used commercially or industrially. It is also explicitly contemplated that a plurality of refrigerators in accordance with the present invention could be installed in a single installation at location to provide a larger number of available refrigerated storage zones for assignment or affiliation with users. The present invention encompasses the refrigerator itself but it will also be understood that installations including multiple refrigerators of the present invention would still be within the scope of the claims hereof. In an installation of multiple refrigerators in accordance with the present invention, the zone opening controllers of each of the plurality of refrigerators could share a network connection to the server, or they might each have their own network connection. Both such approaches are contemplated within the scope hereof as well.

In most embodiments of the refrigerator of the present invention the entire refrigerated enclosure and all of its refrigerated storage zones would likely be maintained in a single refrigerated temperature. In certain other embodiments it will be understood that if the necessary equipment alterations were made to the enclosure overall, the refrigerated enclosure could permit the variation of temperature settings between different refrigerated storage zones. It will be understood that both such approaches are contemplated within the scope of the present invention. While not explicitly claimed, the refrigeration equipment and power supply of the refrigerators are also understood to those skilled in the art to be within the scope of the refrigeration devices as will be manufactured.

The mobile multizone refrigerator of the present invention would be actuated for the opening of refrigerated storage zones therein where the server was one of many different embodiments as will be understood to those skilled in the art. In certain embodiments of the present invention the server would comprise a processor and memory along with a server software component for facilitating the steps of the method of opening the various refrigerated storage zones as required or requested by their affiliated users.

The server would also comprise or be operatively connected to his own database comprising a plurality of zone records each corresponding to a storage zone of the multizone refrigerator. Each zone record would contain a zone address for the corresponding refrigerated storage zone along with at least the identification credentials of the affiliated user of the zone. In other embodiments, the identification credentials of the affiliated user could be stored in a separate dataset linkable to the zone records, as will be understood to those skilled in the art of relational database design, and both such approaches are contemplated within the scope of the present invention.

The server and the server software component will facilitate the use of the refrigerator of the present invention and the opening of storage zones as required by receiving zone opening requests from network connected user devices. A zone opening request when received would contain at least a zone address and identification connections of a user. On receipt of a zone opening request the server would authenticate request by matching the received zone address and user credentials against the zone records and zone database. If a matched zone record is identified i.e. I zone record that corresponds to a particular zone address of a refrigerated storage zone in the refrigerator and provide the necessary and matching user credentials for the affiliated user, the zone opening request is accepted.

Where a zone opening request is accepted, the server and the server software component will facilitate the opening of the corresponding addressed refrigerated storage zone by transmitting a zone opening instruction to the zone opening controller of the refrigerator associated with zone identified in the matched zone record, whereupon the zone opening controller upon receipt of such instruction will process same and unlock the lock of the addressed zone. Once the user was done with placement of items into or out of the opened zone, they could reclose and lock the door, and open it again for further access to the compartment at a later time by providing another zone opening request to the server.

In addition to the mobile multizone refrigerator disclosed in accordance with the present invention, the invention in further embodiments comprises a mobile multizone refrigeration system for secure use by a plurality of users. The system comprises at least one refrigerated enclosure as outlined above. Each refrigerated enclosure comprises a plurality of refrigerated storage zones each of which is affiliated with a user, and having a lockable door on each refrigerated storage zone. The lockable door includes an electronically actuated lock connected to a zone opening controller which is capable of triggering the unlocking of each connected lock and corresponding zone. In addition to the refrigerated storage zones and lockable doors with locks thereon, each refrigerated enclosure also comprises a zone opening controller comprising at least a processor and a memory, network interface for network communication with a server, as well as controller software and the local control bus connected to each block such that the zone opening controller can actuate the locks as required.

In addition to the at least one refrigerated enclosure, the system also comprises a server in network communication with user devices of users as well as with each zone opening controller. The server comprises a processor, memory in a server software component, along with a zone database comprising a plurality of zone records each of which corresponds to a storage zone of the multizone refrigerator system. The zone records would each include a zone address for the zone in question as well as at least identification credentials of the affiliated user of the zone.

The zone address which is used to identify and trigger the opening a particular refrigerated storage zones would be a network address, or other identifying information is required to facilitate the transmission by the server to the corresponding zone opening controller of the zone opening instruction. Any type of a network address or other coordinates for the purpose of facilitation of this aspect of the present invention will be understood to be within the scope of the concept of the zone address.

In operation of the system, the server and server software can open storage zones as required by receiving zone opening requests from network connected user devices, each of which contains at least a zone address and identification credentials of a user. On receipt of a zone opening request, the server and the server software will match the received zone address and user credentials from the request against the zone records in the zone database and if of matched zone record exists i.e. the zone address and user credentials provided are authenticated, the zone opening request is accepted.

Where zone opening request is accepted, the server will transmit a zone opening instruction to the controller of the refrigerator associated with the zone identified in the matched zone record, and on receipt of a zone opening instruction the receiving zone opening controller will trigger the unlocking of the lock of the addressed zone via its connection to the local control bus.

User devices of affiliated users who wish to open refrigerated storage zones in the system or refrigerator of the present invention could communicate with the server for the purpose of initiating zone opening requests either by a locally installed software application on the user device capable of network communication with the server as required, or in other embodiments the server could be a Web server which would provide a browser-based zone opening data entry interface to the browser user devices through which by proper authentication the necessary information could be transmitted to generate a zone opening request. Both such approaches are contemplated within the scope of the present invention.

Also disclosed is a method of use of the mobile multizone refrigeration system by a plurality of users, using a system in accordance with the remainder of the present invention. Any use of a multizone refrigerator or multizone refrigerator system as outlined above resulting in the ability for a user to trigger the unlocking of an affiliated refrigerated storage zone will be understood to be within the scope of the present invention.

The server software component capable of facilitating the method of the present invention and as outlined and claimed is also intended to be within the scope of the present invention.

The various embodiments of the present invention will provide the ability for a user to become affiliated with a refrigerated storage zone in a multizone refrigerator system such as outlined, and to upon the provision of necessary authentication information trigger the unlocking of their affiliated storage zone for the purpose of placement into or out of the storage zone of items for refrigeration.

### DESCRIPTION OF THE DRAWINGS

To easily identify the discussion of any particular element or act, the most significant digit or digits in a reference number refer to the figure number in which that element is first introduced. The drawings enclosed are:

FIG. 1 is a perspective view of a multizone refrigerator in accordance with the present invention;

FIG. 1A shows a cutaway detail of the door and related components of a refrigerated storage zone in accordance with the embodiment of FIG. 1;

FIG. 2 is a block diagram showing the components of a zone opening controller in accordance with the embodiment of FIG. 1;

FIG. 3 is a schematic showing one embodiment of the local control bus of the present invention, for consideration in conjunction with FIGS. 1 and 2;

FIG. 4 is a block diagram showing the components of a server in accordance with the present invention;

FIG. 5 is a network diagram demonstrating the configuration of the components in one embodiment of the system in accordance with the present invention; and

FIG. 6 is a flowchart demonstrating the steps in one embodiment of the method of use of the mobile multizone refrigeration system as outlined herein.

### DETAILED DESCRIPTION OF ILLUSTRATED EMBODIMENTS

As outlined herein, the present invention comprises a multizone refrigerator and related system and software components for the secure use of refrigerated storage zones by a plurality of users.

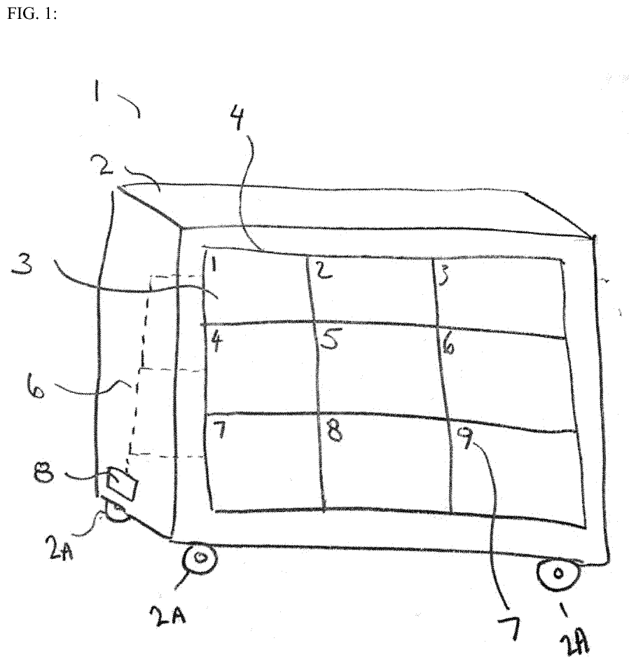

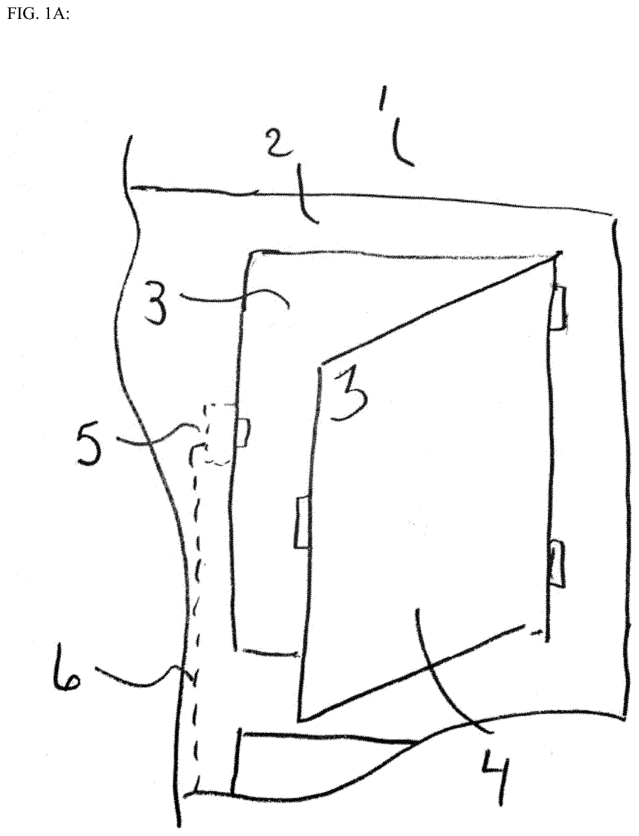

Referring to FIG. 1 there is shown a perspective line view of a embodiment of a mobile multizone refrigerator 1 for secure use by a plurality of users in accordance with the present invention. It is specifically contemplated that the multizone refrigerator of the present invention will be mobile and non-movable, for permanent or semipermanent installation at a location to enhance security of the unit as a whole as well as to minimize maintenance requirements.

As outlined elsewhere herein, the refrigerator 1 comprises a refrigerated enclosure 2 which has a plurality of refrigerated storage zones 3 therein. The embodiment shown includes nine refrigerated storage zones 3. The refrigerator 1 includes movement means 2A, which as shown are a plurality of casters which would permit for the movement of the refrigerator 1 between locations. Many different types of movement means which could allow for the ability of the refrigerator between locations will be understood to be within the scope of the present invention.

FIG. 1A is a cutaway detail view of the door and related components of a particular refrigerated storage zone 3 of the refrigerated 1. As is shown, each refrigerated storage zone 3 includes a lockable door 4 which permits for secure storage of items requiring refrigeration within the refrigerated storage zone 3. The door 4 includes an electronically actuated lock 5 which in addition to any required power supply is operatively connected via a local control bus 6 to a zone opening controller capable of triggering the unlocking of the lock 5 and the corresponding door 4 as required.

Each refrigerated storage zone 3, either physically or on the system level, has a zone address 7. In this case the zone address 4 is shown physically lettered onto the doors 4 of each of the refrigerated storage zones 3 of this Figure. Physically displaying the zone address 7 in respect of individual doors 4 would be helpful in a more public facing embodiment of the invention, since having the ability to identify your own affiliated or assigned storage zone 3 by finding the zone address 7 lettered thereon might be helpful. However it will be understood that in other embodiments, the zone address 4 might be a virtual concept which was not physically attached to the door 4 of a particular refrigerated storage zone 3 and both such approaches are contemplated within the scope of the present invention.

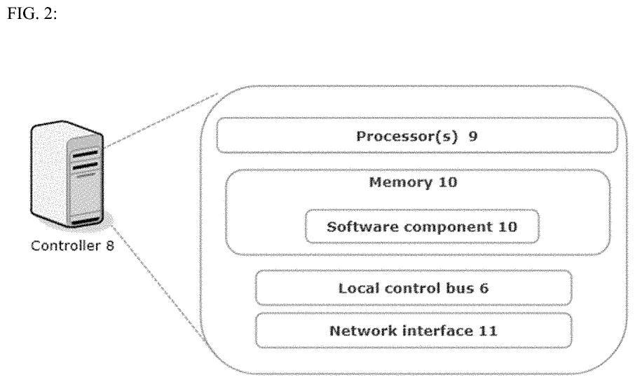

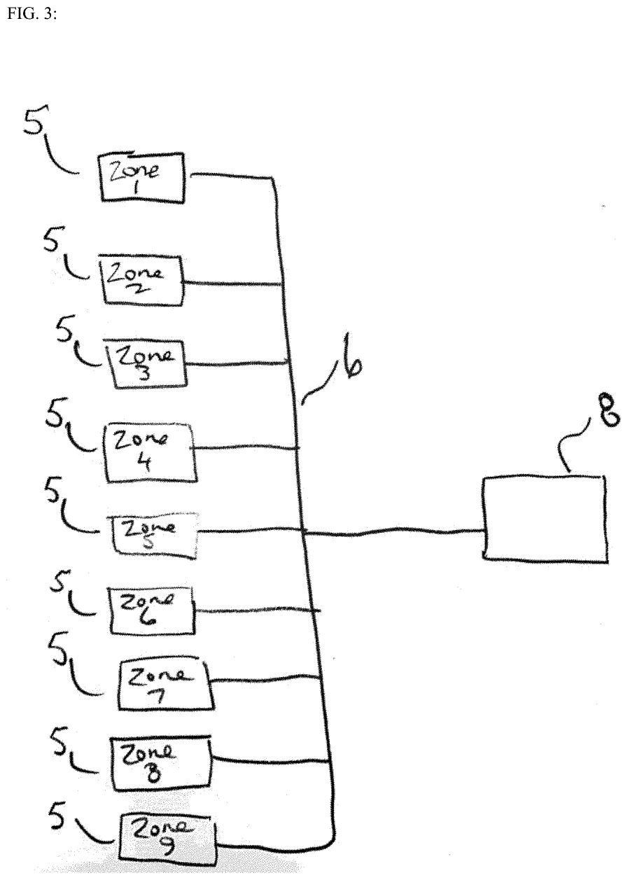

FIGS. 2 and 3 facilitate the comprehension of the zone opening controller 8 as well as the local control bus network 6 outlined in further detail below. The local control bus 6 connects the locks 5 of each storage zone 3 to a zone opening controller 8. As shown in FIG. 3, the local control bus 6 includes a connection to a zone opening controller 8 as well as to each of the locks 5 corresponding to each storage zone 3.

The zone opening controller 8 in addition to a local control bus connection 6 comprises a processor 9 and memory 10 along with a network interface for network communication of the zone opening controller 8 with a server. The network interface is shown at 11. The controller 8 will also store within its memory 10 for operation and execution controller software 12 for the facilitation of the remainder of the method. The zone opening controller 8 could comprise a traditional personal computer or computing terminal, with an appropriate local control bus 6 including a serial port or the like incorporated therein. Alternatively the zone opening controller 8 could comprise a purpose built hardware controller or the like. Any type of a hardware controller which would achieve the desired effect here and be capable of the necessary network communications and local control is contemplated within the scope of the present invention.

The controller 8 will be capable of unlocking the lock 5 and the door 4 of a particular storage zone 3 upon receipt of a zone opening instruction transmitted by a server on the network interface 11, which corresponds to a zone opening request received at the server on behalf of the affiliated user of the storage zone.

The refrigerator 1 which is shown is explicitly contemplated to be maintained in a single refrigerated temperature throughout the entirety of the enclosure and its storage zones. As outlined elsewhere herein, alternate refrigerator systems could be contemplated in which it would be possible to vary the temperature settings between different refrigerated storage zones 3 both such approaches are contemplated within the scope of the present invention.

Zone Address:

As outlined throughout, both in terms of physical display and the control methodology, the zone address 7 assigned to particular storage zones 3 might include a detailed network address corresponding to the particular door 4 and the particular zone opening controller 8, wherein other cases the zone address 7 might be a virtual address assigned and mapped to the network address of the lock 5 or the zone opening controller 8 in question, or even a serial record identifier in the zone database. The zone address 7 might be unique across a system including a plurality of locations or a plurality of refrigerated enclosures, or the zone address 7 might be repeated in respect of individual refrigerators or enclosures. The concept of requiring a zone address 7 to facilitate the lock triggering of the method of the present invention will be understood to those skilled in the art and any concept of a zone address 7 for use in conjunction with the remainder of the method and the system here are contemplated within the scope of the present invention as claimed.

Server

The remote opening method of the present invention in respect of individual refrigerated storage zones 3 within a refrigerated 1 in accordance with the present invention relies upon a server 15 operatively connected to the zone opening controller 8 via corresponding network interfaces for the purpose of triggering the opening of individual refrigerated storage zones 3 by actuating the associated locks 5.

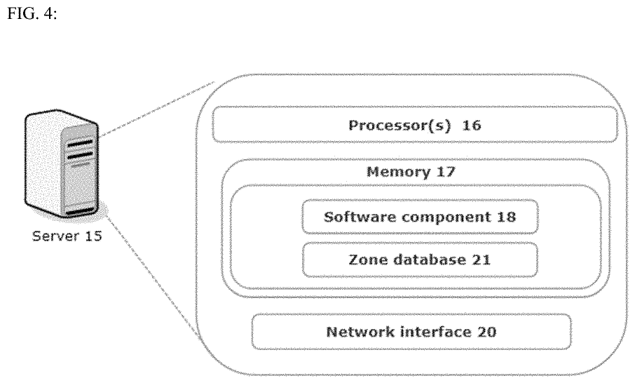

Referring to FIG. 4 there is shown a block diagram of the components of one embodiment of a server in accordance with the present invention. The server 15 might consist of one or more servers 15—a single server or a server farm approach. Each server 15 would comprise one or more processors 16 and memory 17. The memory 17 might contain various software components are a series of processor instructions for use in the method of the present invention or otherwise in the operation of the server 15. Processor instructions corresponding to the server software component 18 are shown stored within the memory 17 in this Figure.

Memory 17 may comprise non-transitory storage media that electronically stored information. The electronic storage media or memory 17 might include one or both of system storage that is provided integrally i.e. substantially nonremovable with the server 15, and or removable storage that is removably connected to the server 15 via for example a port or a drive. Memory 17 might also include one or more of optically readable storage media, magnetically readable storage media, electrical charge based storage media, solid-state storage media and/or other electronically readable storage media. The memory 17 might also include one or more virtual storage resources such as cloud storage, VPN storage or other virtual storage resources. The memory 17 may store software algorithms, information determined by the processor 15, information otherwise received from user devices or zone opening controllers and/or other information that enables the server 15 to function as described herein.

The processors 16 might be configured to provide information processing capabilities and the server 15 including one or more of a digital processor, an analog processor, digital circuit designed to process information, and analog circuit design to process information, state machine and/or other mechanisms for electronically processing information. In some implementations processors 16 might include a plurality of processing units physically located within the same device or separate devices operating in coordination.

The server 15 would also include at least one network interface 20 by which it could communicate with the at least one communications network for the purpose of enabling communication with user client devices as well as with zone opening controllers of the remainder of the method and system as outlined herein. It will be understood by those skilled in the art of network design and hardware and software design that certain server architectures might include more than one network interface 20 and any type of a server 15 a network interface 20 design which enabled the necessary communication of the server 15 as outlined in the remainder of the system and method of the present invention will be contemplated within the scope hereof.

Server Software Component:

Functions of the server software component 18 resident on or accessible to the server 15 would include the creation, administration and maintenance of database records along with interacting with user client devices and zone open controllers as required for the purpose of facilitating the method. The server software component 18 would also be capable of encompassing any additional required querying, reporting or added software functionality. In many embodiments the server 15 is contemplated to be a Web server where user client devices would use a web browser for interaction with. In other cases a local software application could be developed to communicate between user devices and the server 15 in which case the server 15 might not be a Web server per se but might be a server 15 capable of interaction with that type of an interface on remote user devices and all such approaches contemplated within the scope of the present invention.

Zone Database:

The memory 17 of the server 15 will contain or be operatively connected to a plurality of data structures required for the operation of the system and method of the present invention. In the embodiments shown, the first of these is a zone database 21. The zone database 21 comprises a plurality of zone records each of which corresponds to a subject refrigerated storage zone 3 within a refrigerator 1 which is desired to be controlled in accordance with the present invention. A zone record corresponding to each refrigerated storage zone 3 would be stored within the database 21. The zone record would include a zone address 7 in respect of the zone 3.

The zone record also includes at least identification credentials of an affiliated user of the zone 3—for example username and password or whatever other type of credentials would be structured for use to validate the request to open a particular refrigerator zone 3. There are virtually limitless data structures were to be used for the zone database 21 without departing from the intended scope and direction of the present invention outlined and any type of a data structure which achieves the objective of containing the necessary zone address and user authentication credentials is contemplated within the scope of the present invention.

In the embodiments as outlined, the zone records in the zone database 21 include user identification and authentication information to permit the authentication of zone opening request in respect of the corresponding refrigerated storage zone 3. In other embodiments the present invention, user authentication credentials can be achieved either by storage of user information in a separate database table, or even using a separate identity service and the necessary modifications to the system and method of the present invention to achieve these objectives will be understood to be within the scope of the present invention as well.

System Architecture:

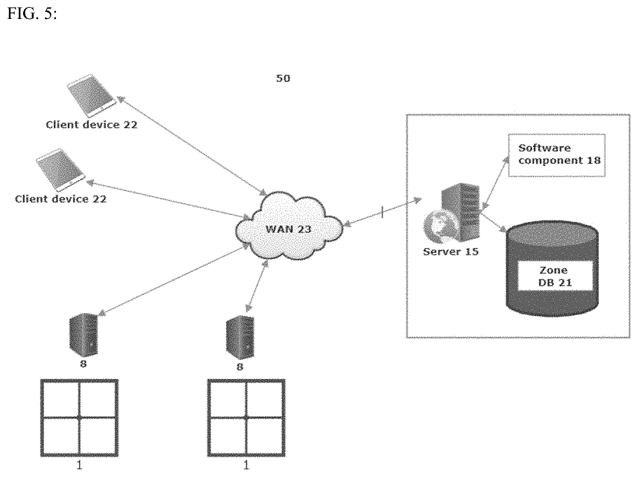

Referring next to FIG. 5 there is shown a sample architecture of a system 50 in accordance with the present invention. A plurality of refrigerators 1 in accordance with the present invention are shown, in addition to a server 15. A plurality of user client devices 22 are also shown. The user client devices 22 would be any type of a device capable of communication and interaction with the server 15 for the formulation and transmission of zone opening requests. The wide area network 23, specifically likely the Internet, connecting the server 15, and the zone opening controllers 8 of each refrigerator 1 as well as the plurality of user client devices 22 are also shown.

The system 50 permits the actuation of locks and doors on multiple refrigerated storage zones 3 in multiple refrigerators 1 in accordance with the present invention.

A user, using a user client device 22 can initiate a communication session with the server 15 by the network 23, for the purpose of transmitting a zone opening request to the server in accordance with the remainder of the method. The server 15 and the software component 18 in combination with the data structures and the remainder of the software resident there and will permit the remotely triggered actuation or opening of the locks on individual refrigerated storage zones 3 within a refrigerator in accordance with the present invention.

Method Overview:

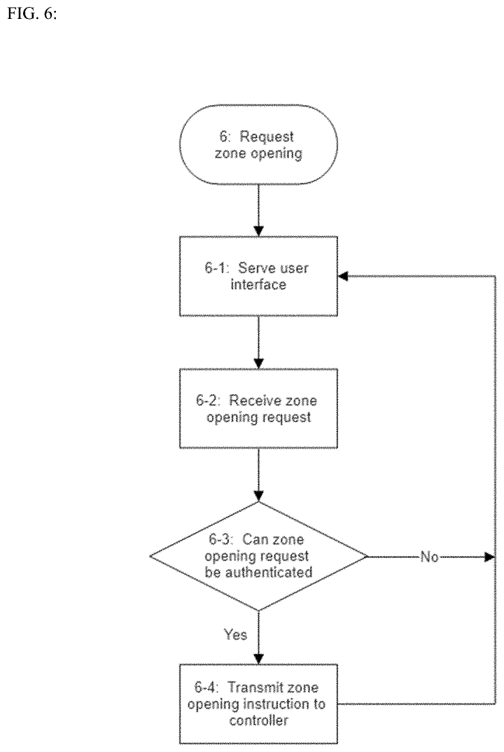

Referring next to FIG. 6 there is shown a flowchart demonstrating the steps in one embodiment of a method in accordance with the present invention. This would be a method in accordance with the use of the system of FIG. 5. The flowchart of this Figure shows a single zone opening data transaction. It will be understood that typically in a client/server method such as is contemplated in the control system outlined herein, the software would actually facilitate these types of transactions in a repeated or looped basis and that will be understood to those skilled in the art of software design and is obviously intended to be encompassed within the scope of the present invention.

The zone database 21 would be pre-populated with zone records and affiliated user credentials as required.

A user wishing to access their affiliated refrigerated storage zone 3 would initiate a communication session between their user client device 22 and the server 15. The server, as shown at step 6-1, can serve an interface or communicate with the local application at the user client device 22 for the purpose of communication including formulating or receiving zone opening requests.

Via a browser interface, local application or otherwise, the user by other user client device 22 would transmit a zone opening request to the server 15 where it would be received. Receipt of the zone opening request at the server 15 is shown at step 6-2.

As outlined throughout, the zone opening request would be a data packet including at least information corresponding to a zone address 7 of a requested refrigerated storage zone 3 to be opened as well as user identification credentials. On receipt of a zone opening request at the server 15, the server software component 18 would authenticate the request by attempting to match it against zone records in the zone database 21. If the zone address indication as well as the user identification credentials provided in the zone opening request match a zone record in the zone database 21, the zone opening request is an accepted zone opening request. Authentication and acceptance of the zone opening request is shown at step 6-3. As shown, if the zone opening request received is not authenticated, the software component 18 can continue its listing loop for other zone opening requests to be received etc.

When a zone opening request is accepted, the server will open the corresponding storage zone. This will be done by the server 15 initiating a transmission of a zone opening instruction to the zone opening controller 8 corresponding to and connected by the local control bus to the lock 5 of the refrigerated storage zone 3 to be opened. Transmission of the zone opening instruction is shown at step 6-4.

On receipt of a zone opening instruction, the corresponding zone opening controller will parse the information contained in that instruction or data packet and trigger the opening of the corresponding lock 5 and/or 4 by a control signal on the local control bus 6.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A mobile multi-zone refrigerator for secure use by a plurality of users, said refrigerator comprising:
a. a refrigerated enclosure comprising a plurality of refrigerated storage zones each affiliated with a user;
b. movement means to render the refrigerator moveable between locations;
c. a lockable door on each refrigerated storage zone, each lockable door including an electronically actuated lock connected to a zone-opening controller capable of triggering the unlocking of each connected lock and corresponding zone;
d. a zone-opening controller comprising at least:
i. a processor and memory;
ii. a network interface for network communication of the zone-opening controller with a server;
iii. a local control bus connected to each lock; and
iv. controller software;
wherein the controller can unlock the lock and door of a particular storage zone upon receipt of a zone-opening instruction from the server corresponding to a zone-opening request received at the server on behalf of the affiliated user of the storage zone.

2. The mobile multi-zone refrigerator of claim 1 wherein the movement means comprises a plurality of casters permitting the rolling movement of the refrigerator.

3. The mobile multi-zone refrigerator of claim 1 wherein the entire refrigerated enclosure and all of its storage zones are maintained at a single refrigerated temperature.

4. The mobile multi-zone refrigerator of claim 1 wherein the refrigerated enclosure permits varying temperature settings between different refrigerated storage zones.

5. The mobile multi-zone refrigerator of claim 1 wherein the server comprises:
a. a processor and memory;
b. a server software component; and
c. a zone database comprising a plurality of zone records, each zone record corresponding to a storage zone of the multizone refrigerator and containing a zone address and at least identification credentials of an affiliated user of the zone;
wherein the server and server software can open storage zones as required by:
a) receiving zone-opening requests from network-connected user devices, each said request containing at least a zone address and identification credentials of a user;
b) on receipt of a zone-opening request, matching the received zone address and user credentials from the zone-opening request against the zone records in the zone database, wherein if a matched zone record is identified the zone-opening request is accepted;
c) on acceptance of a zone-opening request, transmitting a zone-opening instruction from the server to the controller of the refrigerator associated with the zone identified in the matched zone record, whereupon said controller will process said instruction and unlock the lock of the addressed zone.

6. A mobile multi-zone refrigeration system for secure use by a plurality of users, said system comprising:
a. at least one mobile refrigerator comprising:
i. movement means to render the refrigerator moveable between locations;
ii. a plurality of refrigerated storage zones each affiliated with a user;
iii. a lockable door on each refrigerated storage zone, each lockable door including an electronically actuated lock connected to a zone-opening controller capable of triggering the unlocking of each connected lock and corresponding zone;
iv. a zone-opening controller comprising at least:
1. a processor and a memory;
2. a network interface for network communication of the zone-opening controller with a server;
3. a local control bus connected to each lock; and
4. controller software;
b. a server in network communication with user devices of users as well as with each zone-opening controller, said server comprising:
i. a processor and memory;
ii. a server software component; and
iii. a zone database comprising a plurality of zone records, each zone record corresponding to a storage zone of a refrigerated enclosure and comprises a zone address and at least identification credentials of the affiliated user of the zone;
wherein the server and server software can open storage zones as required by:
a) receiving zone-opening requests from network-connected user devices, each said request containing at least a zone address and identification credentials of a user;
b) on receipt of a zone-opening request, matching the received zone address and user credentials from the zone-opening request against the zone records in the zone database, wherein if a matched zone record is identified the zone-opening request is accepted;
c) on acceptance of a zone-opening request, transmitting a zone-opening instruction from the server to the controller of the refrigerator associated with the zone identified in the matched zone record;
whereby upon receipt of a zone-opening instruction, the receiving zone-opening controller will trigger the unlocking of the lock of the addressed zone via its connection to the local control bus.

7. The multizone refrigeration system of claim 6 wherein the movement means on each refrigerated enclosure comprises a plurality of casters permitting the rolling movement of the enclosure.

8. The multizone refrigeration system of claim 6 wherein the user devices communicate with the server for the purpose of initiating zone-opening requests by a locally installed software application on the user device.

9. The multizone refrigeration system of claim 6 wherein the server is a Web server, and the server will serve a zone-opening data entry interface to the browser of user devices.

10. The multizone refrigeration system of claim 6 wherein the number of refrigerated enclosures is one.

11. The multizone refrigeration system of claim 6 wherein the number of refrigerated enclosures is more than one.

12. A method of use of a multi-zone refrigeration system by a plurality of users using a system comprising:
a. at least one refrigerator comprising:
i. a plurality of refrigerated storage zones each affiliated with a user;
ii. a lockable door on each refrigerated storage zone, each lockable door including an electronically actuated lock connected to a zone-opening controller capable of triggering the unlocking of each connected lock and corresponding zone;
iii. a zone-opening controller comprising at least:
1. a processor and a memory;
2. a network interface for network communication of the zone-opening controller with a server;
3. a local control bus connected to each lock; and
4. controller software;
iv. a server in network communication with user devices of users as well as with each zone-opening controller, said server comprising:
b. a server in network communication with user devices of users as well as with each zone-opening controller, said server comprising:
i. a processor and memory;
ii. a server software component; and
iii. a zone database comprising a plurality of zone records, each zone record corresponding to a storage zone of the multizone refrigerator and at least identification credentials of the affiliated user of the zone;
wherein the method comprises using the server and software component to:
a) affiliate users with at least one storage zone as required by storing at least identification credentials of the user in zone records corresponding to zones to be affiliated therewith;
b) open storage zones in the secure refrigerator as required by as required by:
a. permitting the data entry and transmission of a zone-opening request from a network-connected user device to the server, said request containing at least the zone address and identification credentials of the affiliated user;
b. on receipt of a zone-opening request, matching the received zone address and user credentials from the zone-opening request against the zone records in the zone database, wherein if a matched zone record is identified the zone-opening request is accepted; and
c. on acceptance of a zone-opening request, transmitting a zone-opening instruction from the server to the controller of the refrigerator associated with the zone identified in the matched zone record;
whereby upon receipt of a zone-opening instruction, the receiving zone-opening controller will trigger the unlocking of the lock of the addressed zone via its connection to the local control bus.
